(19) United States
(12) Patent Application Publication
(10) Pub. No.: US 2007/0259081 A1
(43) Pub. Date: Nov. 8, 2007

(54) Sparkling juice antioxidant beverage composition

(75) Inventors: Danielle Downes, Lake Mary, FL (US); Diane Alder, Houston, TX (US); Victoria Reid, Houston, TX (US)

Correspondence Address: MORRISON & FOERSTER LLP, 1650 TYSONS BOULEVARD, SUITE 400, MCLEAN, VA, 22102, US

(73) Assignee: The Coca-Cola Company, Atlanta, GA (US)

(21) Appl. No.: 11/418,463

(22) Filed: May 5, 2006

(51) Int. Cl. A23F 3/16

(52) U.S. Cl. 426/330.3

(57) ABSTRACT

A sparkling juice beverage comprising carbonated water, juice concentrate, antioxidants Vitamins C and E, green tea extract and grape seed extract. The beverage may be sweetened with natural sweeteners, artificial sweeteners, or combinations thereof. The sparkling juice beverage of the invention provides a delicious and refreshing way to give the body important antioxidants for body health.

### BACKGROUND OF THE INVENTION

This invention relates to the field of beverages, particularly carbonated juice beverages having antioxidant additives.

The healthful benefits of antioxidants have long been known. Specifically, antioxidants help to prevent cellular damage by interacting with free radicals formed as a result of oxidation during normal biochemical processes in the body. These highly reactive free radicals readily react with other molecules and the chain reaction they start can cause damage to other molecules including DNA and other cellular components. This damage is a common pathway for aging and a variety of diseases, including cancer.

Antioxidants are the body's mechanism for removing free radicals from the system by safely interacting with the free radicals and terminating the chain reaction before cell damage occurs. Two of the primary antioxidants used by the body are Vitamins C and E. Vitamin E, or d-alpha tocopherol, is a fat soluble vitamin present in nuts, seeds, vegetable and fish oils, whole grains (esp. wheat germ), fortified cereals, and apricots. Vitamin C, or ascorbic acid, is a water soluble vitamin present in citrus fruits and juices, green peppers, cabbage, spinach, broccoli, kale, cantaloupe, kiwi, and strawberries.

The body cannot manufacture these chemicals, so they must be provided in the diet. The current recommended daily allowance (RDA) for Vitamin E is 15 IU per day for men and 12 IU per day for women. The RDA for Vitamin C is 60 mg per day.

Other materials have also been reported as antioxidants, although the FDA does not permit antioxidant claims to made in connection with these materials. Grape seed extract, for example, contains a concentrated source of oligomeric proanthocyanidins, which have been reported to be potent antioxidants. Grape seed extract is also rich in polyphenols, which have also been reported to be antioxidants. However, grape seed extract is known to have a very bitter taste that is difficult to disguise in foods and beverages without high doses of sugar or other high calorie foods.

Another material that has been reported to have high levels of antioxidants is green tea extract. Green tea extract has high levels of polyphenols and EGCG, another reported potent antioxidant. However, like grape seed extract, green tea extract is also known to have a very bitter taste that is difficult to disguise in foods and beverages without high doses of sugar or other high calorie foods. Artificial sweeteners have heretofore not been successfully used to improve the bitter taste of grape seed and green tea extracts, possibly because of the bitterness associated with artificial sweeteners.

While the aforementioned vitamins and extracts are known for their beneficial health properties, they have not heretofore been combined in a healthful and refreshing sparkling juice beverage.

### BRIEF SUMMARY OF THE INVENTION

It is an object of the invention to provide an artificially sweetened sparkling juice beverage with added Vitamin C, Vitamin E, green tea extract and grape seed extract. The sparkling juice beverage of the invention is formulated to provide the benefits of Vitamins C and E, as well as green tea extract and grape seed extract, but without the bitter taste associated with green tea extract and grape seed extract. The sparkling juice beverage of the invention may contain between 1% and 10% juice, at least 10% of the Recommended Daily Allowances of Vitamins C and E, and between 0.0025%-0.100% by volume each of green tea extract and grape seed extract.

The sparkling juice beverage of the invention may also include added natural and artificial sweeteners. According to a preferred embodiment of the invention, the sparkling juice beverage comprises about 5% juice and a combination of natural and artificial sweeteners. This combination of juices, natural and artificial sweeteners results in a tasty and healthy sparkling beverage that does not suffer from the bitter taste of green tea extract or grape seed extract.

### DETAILED DESCRIPTION OF THE INVENTION

Table one lists the preferred ingredients of a sparkling fruit juice antioxidant beverage and the ranges in which they may be present according to the invention, the preferred ranges in which they may be present, and the most preferred amount in which they may be present.

TABLE 1
Sparkling Fruit Juice Antioxidant Beverage

| | More Preferred | | Most Preferred | |
|---|---|---|---|---|
| | Relative Amount | | Relative Amount | |
| INGREDIENTS | (% v/v SSJ or g/L) | | (% v/v SSJ or g/L) | |
| WATER | 97-99% | | 98% | |
| CITRIC ACID | 0.18-0.22% | | 0.20% | |
| ASCORBIC ACID | 0.046-0.054 | g/L | 0.05 | g/L |
| HFCS-55 | 0.65-0.79% | | 0.72% | |
| (Brix: 77.0) | | | | |
| FRUIT JUICE | 3.0-7.0% | | 5.3% | |
| CONCENTRATE(S) | | | | |
| FD&C COLOR(S) | 0.0364-0.0444 | g/L | 0.0404 | g/L |
| POTASSIUM | 0.440-0.538 | g/L | 0.489 | g/L |
| SORBATE | | | | |
| SODIUM BENZOATE | 0.196-0.240 | g/L | 0.218 | g/L |
| POTASSIUM | 0.18-0.22 | g/L | 0.200 | g/L |
| CITRATE | | | | |
| EDTA, CALCIUM | 0.022-0.275 | g/L | 0.025 | g/L |
| DISODIUM | | | | |
| SUCRALOSE, | 0.45-0.55 | g/L | 0.495 | g/L |
| LIQUID | | | | |
| CONCENTRATE | | | | |
| ACESULFAME | 0.020-0.024 | g/L | 0.022 | g/L |
| POTASSIUM | | | | |
| FLAVORS/ | 0.99-12.1 | g/L | 1.1 | g/L |
| FLAVORINGS | | | | |
| VITAMIN E | 0.015-0.019 | g/L | 0.017 | g/L |
| GRAPE SEED | 0.050-0.062 | g/L | 0.056 | g/L |
| EXTRACT | | | | |
| GREEN TEA | 0.050-0.062 | g/L | 0.056 | g/L |
| EXTRACT | | | | |
| CARBONATION | 2.5-3.0 | volumes | 2.5 | volumes |

Table two lists the preferred ingredients of a sparkling vegetable juice antioxidant beverage and the ranges in which they may be present according to the invention, the preferred ranges in which they may be present, and the most preferred amount in which they may be present.

TABLE 2
Sparkling Vegetable Juice Antioxidant Beverage

| | More Preferred | | Most Preferred | |
|---|---|---|---|---|
| | Relative Amount | | Relative Amount | |
| INGREDIENTS | (% v/v SSJ or g/L) | | (% v/v SSJ or g/L) | |
| WATER | 88-90% | | 98% | |
| CITRIC ACID | 0.18-0.22% | | 0.20% | |
| ASCORBIC ACID | 0.046-0.054 | g/L | 0.05 | g/L |
| HFCS-55 | 0.65-0.79% | | 0.72% | |
| (Brix: 77.0) | | | | |
| VEGETABLE | 10.0-15.0% | | 12.5% | |
| CONCENTRATE(S) | | | | |
| FD&C COLOR(S) | 0.0364-0.0444 | g/L | 0.0404 | g/L |
| POTASSIUM | 0.440-0.538 | g/L | 0.489 | g/L |
| SORBATE | | | | |
| SODIUM BENZOATE | 0.196-0.240 | g/L | 0.218 | g/L |
| POTASSIUM | 0.18-0.22 | g/L | 0.200 | g/L |
| CITRATE | | | | |
| EDTA, CALCIUM | 0.022-0.275 | g/L | 0.025 | g/L |
| DISODIUM | | | | |
| SUCRALOSE, | 0.45-0.55 | g/L | 0.495 | g/L |
| LIQUID | | | | |
| CONCENTRATE | | | | |
| ACESULFAME | 0.020-0.024 | g/L | 0.022 | g/L |
| POTASSIUM | | | | |
| FLAVORS/ | 0.99-12.1 | g/L | 1.1 | g/L |
| FLAVORINGS | | | | |
| VITAMIN E | 0.015-0.019 | g/L | 0.017 | g/L |
| GRAPE SEED | 0.050-0.062 | g/L | 0.056 | g/L |
| EXTRACT | | | | |
| GREEN TEA | 0.050-0.062 | g/L | 0.056 | g/L |
| EXTRACT | | | | |
| CARBONATION | 2.5-3.0 | volumes | 2.5 | volumes |

Tables 1 and 2 above lists juice concentrates, FD&C colors, and flavors/flavorings among the components of the sparkling juice beverages of the invention. The particular juice concentrates, FD&C colors and flavorings may be selected from a large variety of known juices, colors and flavors according to taste and aesthetic factors. The vitamin E listed above in Tables 1 and 2 may be liquid or encapsulated powder form. The artificially sweetened sparkling juice beverage compositions formulated according to the ranges disclosed in Tables 1 and 2 offer the antioxidant benefits of vitamin C and E as well as green tea and grape seed extracts, but surprisingly do not suffer from the bitterness associated with green tea and grape seed extracts.

The following examples set forth exemplary formulations of sparkling juice health beverages according to the invention.

### EXAMPLE 1

| | Most Preferred | |
|---|---|---|
| | Relative Amount | |
| INGREDIENTS | (% v/v SSJ or g/L) | |
| WATER | 98% | |
| CITRIC ACID | 0.20% | |
| HFCS-55 (Brix: 77.0) | 0.72% | |
| ASCORBIC ACID | 0.05 | g/L |
| FRUIT JUICE CONCENTRATE-A | 5.10% | |
| FRUIT JUICE CONCENTRATE-B | 0.10% | |
| FRUIT JUICE CONCENTRATE-C | 0.10% | |
| FD&C COLOR(S) | 0.0404 | g/L |
| POTASSIUM SORBATE | 0.489 | g/L |
| SODIUM BENZOATE | 0.218 | g/L |
| POTASSIUM CITRATE | 0.200 | g/L |
| EDTA, CALCIUM DISODIUM | 0.025 | g/L |
| SUCRALOSE, LIQUID | 0.495 | g/L |
| CONCENTRATE | | |
| ACESULFAME POTASSIUM | 0.022 | g/L |
| FLAVORS/FLAVORINGS | 1.1 | g/L |
| VITAMIN E | 0.017 | g/L |
| GRAPE SEED EXTRACT | 0.056 | g/L |
| GREEN TEA EXTRACT | 0.056 | g/L |
| CARBONATION | 2.5 | volumes |

This product was prepared by blending vegetable concentrates with sucralose and acesulfame potassium, green tea and grape seed extracts, vitamin E and ascorbic acid, preservatives, FD&C color, HFCS-55, citric acid, and water, and then adding carbonation.

### EXAMPLE 2

| | Most Preferred | |
|---|---|---|
| | Relative Amount | |
| INGREDIENTS | (% v/v SSJ or g/L) | |
| WATER | 98% | |
| CITRIC ACID | 0.20% | |
| HFCS-55 (Brix: 77.0) | 0.72% | |
| ASCORBIC ACID | 0.05 | g/L |
| FRUIT JUICE CONCENTRATE-A | 5.0% | |
| FRUIT JUICE CONCENTRATE-B | 0.10% | |
| FRUIT JUICE CONCENTRATE-C | 0.10% | |
| FRUIT JUICE CONCENTRATE-D | 0.10% | |
| FD&C COLOR(S) | 0.0846 | g/L |
| POTASSIUM SORBATE | 0.489 | g/L |
| SODIUM BENZOATE | 0.218 | g/L |
| POTASSIUM CITRATE | 0.200 | g/L |
| EDTA, CALCIUM DISODIUM | 0.025 | g/L |
| SUCRALOSE, LIQUID | 0.495 | g/L |
| CONCENTRATE | | |
| ACESULFAME POTASSIUM | 0.022 | g/L |
| FLAVORS/FLAVORINGS | 0.90 | g/L |
| VITAMIN E | 0.017 | g/L |
| GRAPE SEED EXTRACT | 0.056 | g/L |
| GREEN TEA EXTRACT | 0.056 | g/L |
| CARBONATION | 2.5 | volumes |

This product was prepared by blending juice concentrates with sucralose and acesulfame potassium, green tea and grape seed extracts, vitamin E and ascorbic acid, preservatives, FD&C color, HFCS-55, citric acid, and water, and then adding carbonation.

### EXAMPLE 3

| | Most Preferred | |
|---|---|---|
| | Relative Amount | |
| INGREDIENTS | (% v/v SSJ or g/L) | |
| WATER | 89% | |
| CITRIC ACID | 0.30% | |
| HFCS-55 (Brix: 77.0) | 0.72% | |
| ASCORBIC ACID | 0.05 | g/L |
| VEGETABLE CONCENTRATE-A | 8.75% | |
| VEGETABLE CONCENTRATE-B | 3.75% | |
| FD&C COLOR(S) | 0.0846 | g/L |
| POTASSIUM SORBATE | 0.489 | g/L |
| SODIUM BENZOATE | 0.218 | g/L |
| POTASSIUM CITRATE | 0.200 | g/L |
| EDTA, CALCIUM DISODIUM | 0.025 | g/L |
| SUCRALOSE, LIQUID | 0.495 | g/L |
| CONCENTRATE | | |
| ACESULFAME POTASSIUM | 0.022 | g/L |
| FLAVORS/FLAVORINGS | 0.80 | g/L |
| VITAMIN E | 0.017 | g/L |
| GRAPE SEED EXTRACT | 0.056 | g/L |
| GREEN TEA EXTRACT | 0.056 | g/L |
| CARBONATION | 2.5 | volumes |

This product was prepared by blending vegetable concentrates with sucralose and acesulfame potassium, green tea and grape seed extracts, vitamin E and ascorbic acid, preservatives, FD&C color, HFCS-55, citric acid, and water, and then adding carbonation.

The foregoing examples are not intended to limit the invention, but are instead intended to merely exemplify particular embodiments within the scope of the invention as defined by the claims. The claims are intended to be construed according to their ordinary meaning, and nothing in this specification is intended to prescribe a narrower meaning to any claim term.

What is claimed as new and desired to be protected by Letters Patent of the United States is:

1. A composition comprising
water in an amount between 97-99% by volume of the total composition;
citric acid in an amount between 0.18 and 0.22% by volume of the total composition;
juice concentrate in an amount between 3.0-7.0% by volume of the total composition;
ascorbic acid in an amount between 0.046-0.054 g/L by weight of the total composition;
natural sweeteners in an amount between 0.65-0.79% by volume of the total composition;
Vitamin E in amount between 0.015-0.019 g/L by weight of the total composition;
green tea extract in an amount between 0.050-0.062 g/L by weight of the total composition;
grape seed extract in an amount between 0.050-0.062 g/L by weight of the total composition;
artificial sweeteners in an amount between 0.47-0.58 g/L by weight of the total composition; and
carbonation in an amount between 2.5 and 3.0 volumes.

2. A composition according to claim 1 comprising
water in an amount of 98% by volume of the total composition;
citric acid in an amount of 0.20% by volume of the total composition;
juice concentrate in an amount of 5.3% by volume of the total composition;
ascorbic acid in an amount 0.05 g/L by weight of the total composition;
natural sweeteners in an amount between 0.65-0.79% by volume of the total composition;
Vitamin E in amount of 0.017 g/L by weight of the total composition;
green tea extract in an amount of 0.056 g/L by weight of the total composition;
grape seed extract in an amount of 0.056 g/L by weight of the total composition
sucralose in an amount between 0.45-0.55 g/L by weight of the total composition;
acesulfame potassium in an amount between 0.020-0.024 g/L by weight of the total composition; and
carbonation in an amount of 2.5 volumes.

3. A composition according to claim 1 comprising
water in an amount of 98% by volume of the total composition;
citric acid in an amount of 0.20% by volume of the total composition;
juice concentrate in an amount of 5.3% by volume of the total composition;
ascorbic acid in an amount 0.05 g/L by weight of the total composition;
HFCS-55 in an amount of 0.72% by volume of the total composition;
Vitamin E in amount of 0.017 g/L by weight of the total composition;
green tea extract in an amount of 0.056 g/L by weight of the total composition;
grape seed extract in an amount of 0.056 g/L by weight of the total composition
sucralose in an amount of 0.495 g/L by weight of the total composition;
acesulfame potassium in an amount of 0.022 g/L by weight of the total composition; and
carbonation in an amount of 2.5 volumes.

4. A composition according to claim 1 comprising
water in an amount of 89% by volume of the total composition;
citric acid in an amount of 0.30% by volume of the total composition;
vegetable juice concentrate in an amount of 12.5% by volume of the total composition;
ascorbic acid in an amount 0.05 g/L by weight of the total composition;
HFCS-55 in an amount of 0.72% by volume of the total composition;
Vitamin E in amount of 0.017 g/L by weight of the total composition;
green tea extract in an amount of 0.056 g/L by weight of the total composition;
grape seed extract in an amount of 0.056 g/L by weight of the total composition
sucralose in an amount of 0.495 g/L by weight of the total composition;
acesulfame potassium in an amount of 0.022 g/L by weight of the total composition; and
carbonation in an amount of 2.5 volumes.
